(19) United States
(12) Patent Application Publication
(10) Pub. No.: US 2003/0210791 A1
(43) Pub. Date: Nov. 13, 2003

(54) Key management

(76) Inventor: Garritt C. Binder, Gilbert, AZ (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/141,486

(22) Filed: May 7, 2002

(51) Int. Cl. H04L 9/00

(52) U.S. Cl. 380/277

(57) ABSTRACT

Disclosed herein are methods, processor programs, and cryptography products for managing cryptographic keys. The methods, processor programs, and cryptography products disclosed herein can protect keys stored in a database against a wide variety of malicious attacks. The methods, processor programs, and products disclosed herein may include a variety of mechanisms that wrap a key in several layers of protection. According to one exemplary embodiment disclosed herein, a method of managing cryptographic keys includes accessing at a server a server key, accessing at the server a client key, accessing at the server an encrypted private key provided by a client, encrypting the encrypted private key with the server key to generate a twice encrypted private key, and encrypting the twice encrypted private key with the client key to generate a thrice encrypted private key.

### BACKGROUND

To communicate securely over a network, computers “scramble” (encrypt) messages they send and “unscramble” (decrypt) messages they receive. This “scrambling” (encryption) and “unscrambling” (decryption) is known as cryptography. In a type of cryptography known as public key cryptography, a user is provided with a public and private key used to encrypt and decrypt messages. For example, if John wants to send a message to Jane, John first encrypts his message with Jane's public key, and then sends his encrypted message to her. After receiving John's encrypted message, Jane may decrypt the message with her private key. Messages encrypted with a public key are exceptionally difficult to decrypt without the corresponding private key.

Typically, public keys are stored in a central database that may be accessed by users who desire to correspond. To preserve the integrity of public key cryptography, a user generally keeps his private key confidential. As suggested above, a user who forgets or loses his private key or who cannot otherwise access the location at which he stored his private key (e.g., a mobile user) will not be able to decrypt messages sent to him.

### SUMMARY

Disclosed herein are methods, processor programs, and products for managing cryptographic keys. The methods, processor programs, and products disclosed herein can protect keys stored in a database against a wide variety of malicious attacks. The methods, processor programs, and products disclosed herein may include a variety of mechanisms that wrap a key in several layers of protection.

According to one exemplary embodiment disclosed herein, a method of managing cryptographic keys may include accessing at a server a server key, accessing at the server a client key, accessing at the server an encrypted private key provided by a client, encrypting the encrypted private key with the server key to generate a twice encrypted private key, and encrypting the twice encrypted private key with the client key to generate a thrice encrypted private key.

According to another exemplary embodiment disclosed herein, a method of managing cryptographic keys may include accessing at a server a server key, accessing at the server a first client key, accessing at the server a first package encrypted with the first client key, the first package including at least an encrypted private key provided by a client and a second client key, decrypting the first package with the first client key, extracting at least the second client key and the encrypted private key from the first package, encrypting the encrypted private key with the server key to generate a twice encrypted private key, and encrypting the twice encrypted private key with the second client key to generate a thrice encrypted private key.

According to one exemplary embodiment disclosed herein, a processor program for managing cryptographic keys may include instructions operable to cause a processor to access at a server a server key, access at the server an encrypted private key provided by a client, and encrypt the encrypted private key with the server key to generate a twice encrypted private key.

According to another exemplary embodiment disclosed herein, a processor program may include further instructions operable to cause a processor to access at the server a client key and encrypt the twice encrypted private key with the client key to generate a thrice encrypted private key.

According to an exemplary embodiment disclosed herein, a product for managing cryptographic keys may include multiple twice encrypted private keys, at least some of the multiple twice encrypted private keys including an encrypted private key provided by a client, the encrypted private key being further encrypted by a server key generated at a server.

### BRIEF DESCRIPTION OF THE DRAWINGS

FIGS. 1A-1K are flow diagrams illustrating a scheme of storing an encrypted private key in a database.

FIG. 2 is a flow chart corresponding to the flow diagrams shown in FIGS. 1A-1K.

FIGS. 3A-3L are flow diagrams illustrating a scheme of retrieving an encrypted private key stored in a database.

FIGS. 4A and 4B are flow charts corresponding to the flow diagrams shown in FIGS. 3A-3L.

FIG. 5 is a diagram illustrating a server storing in a database multiple encrypted private keys provided by multiple clients.

### DETAILED DESCRIPTION

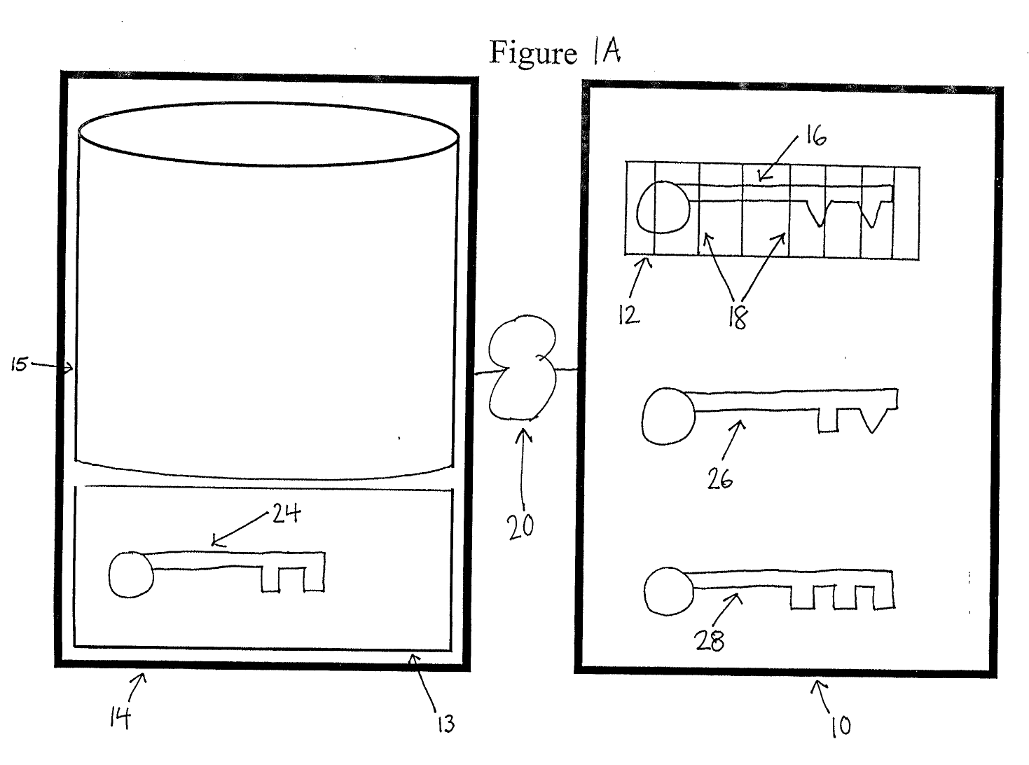

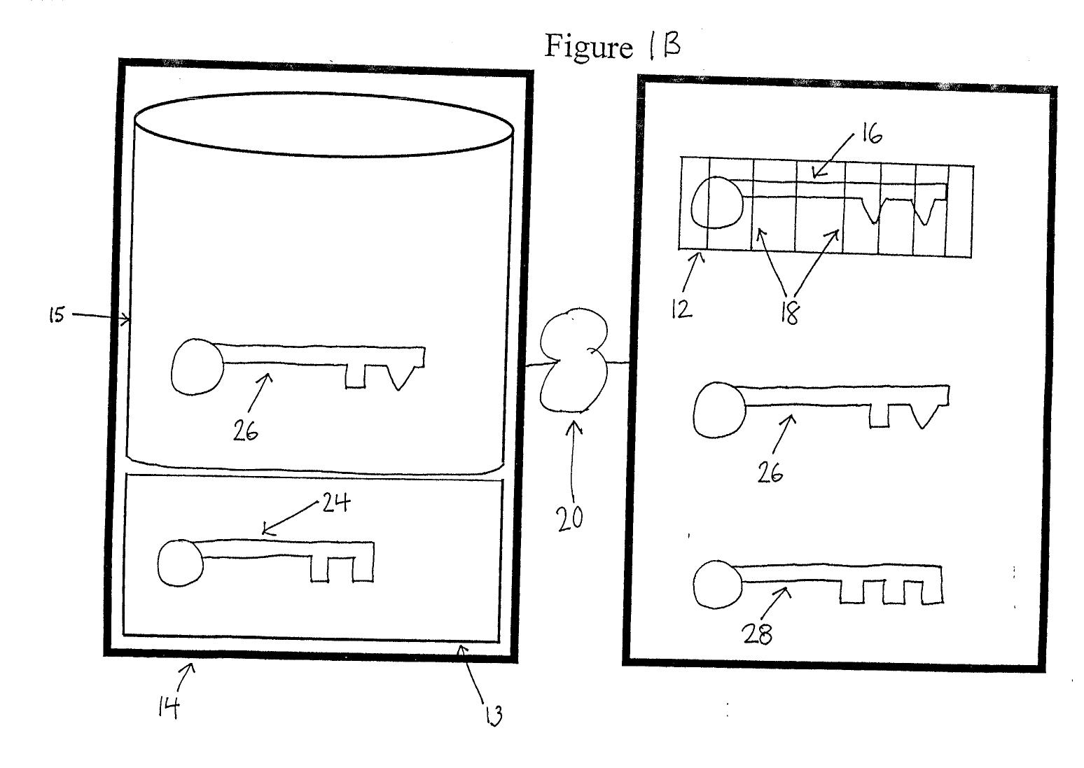

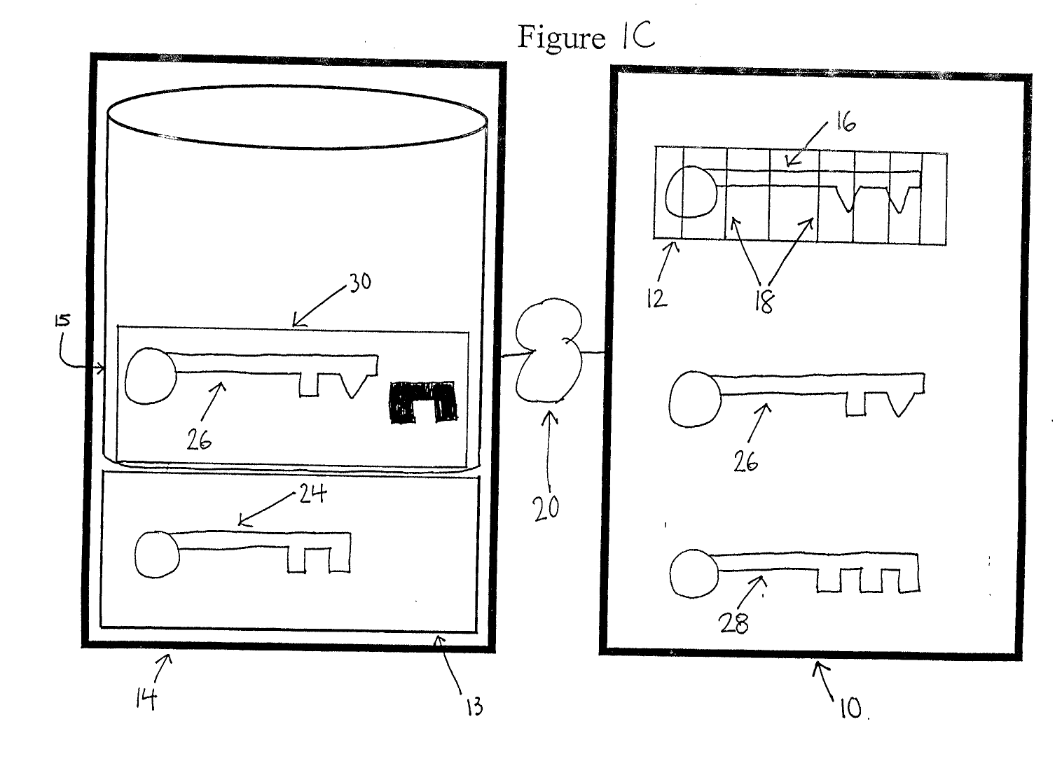

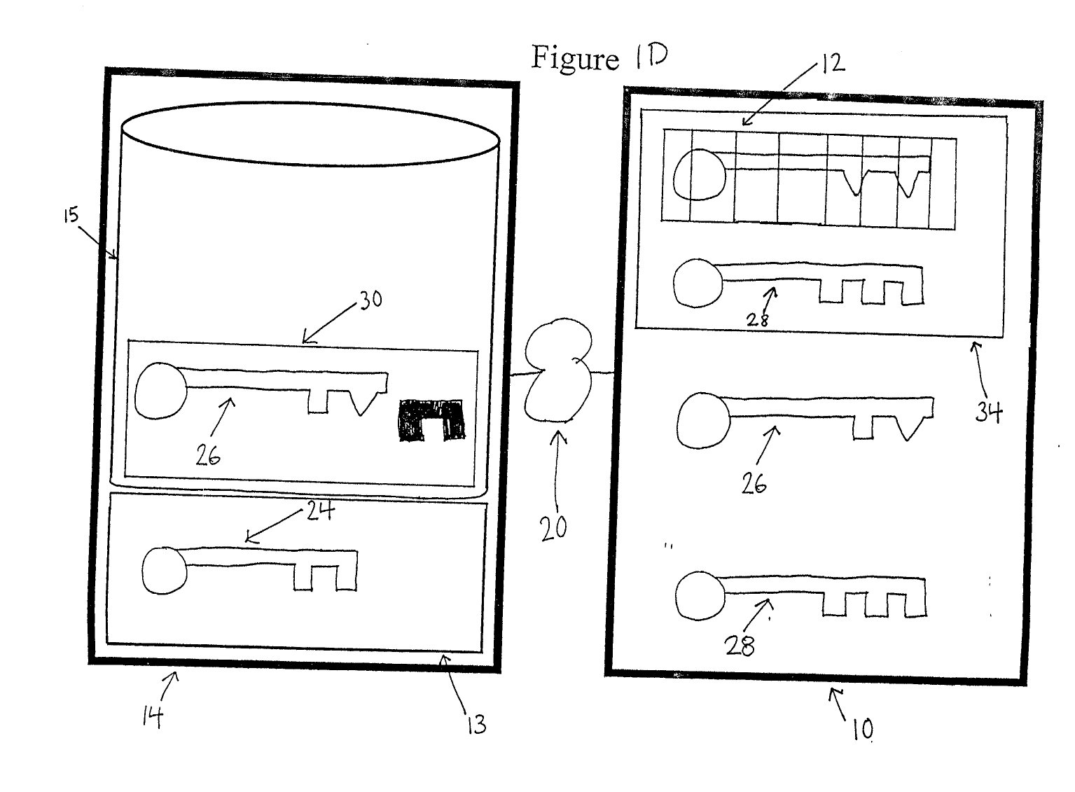

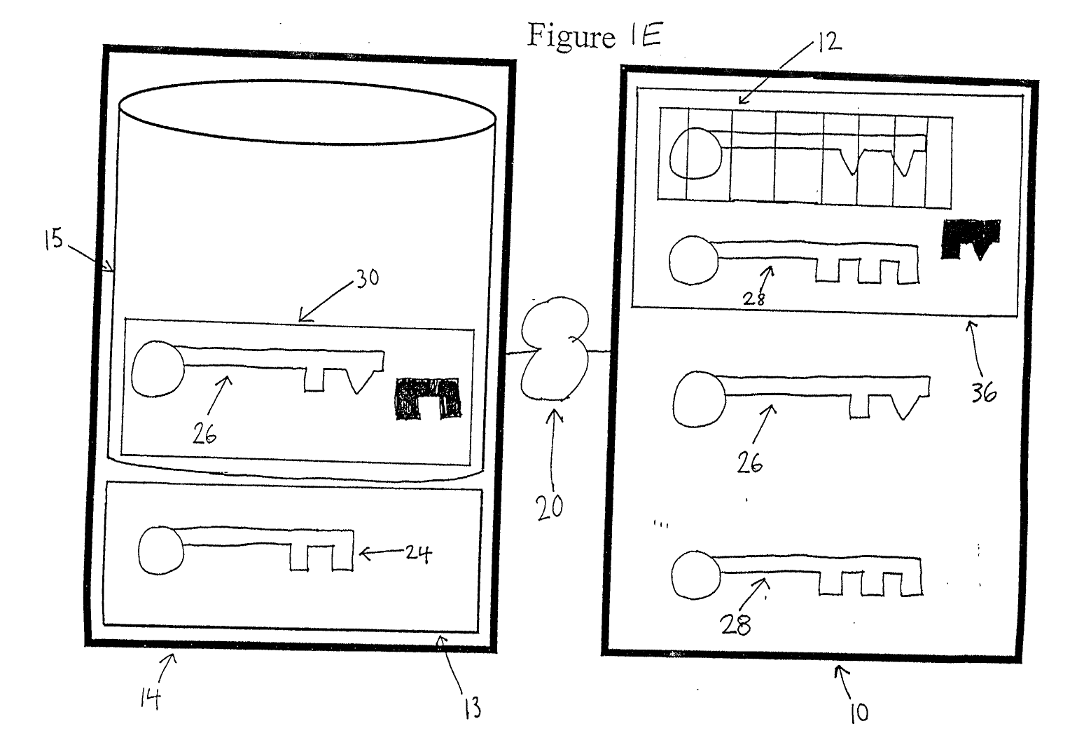

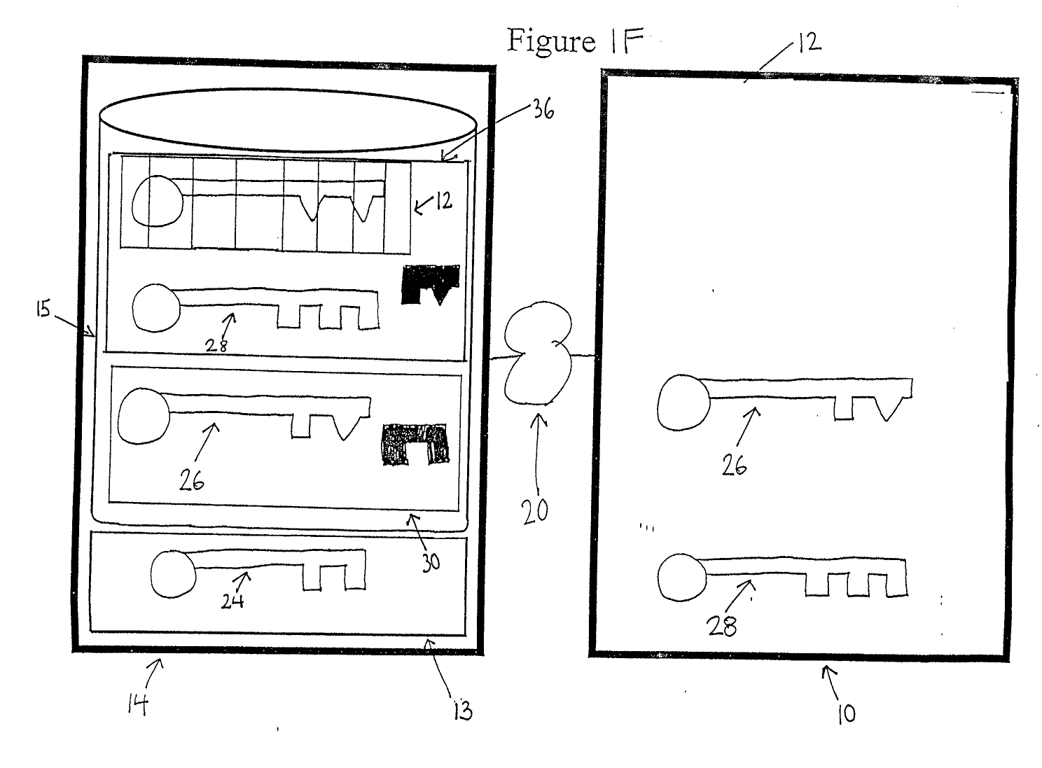

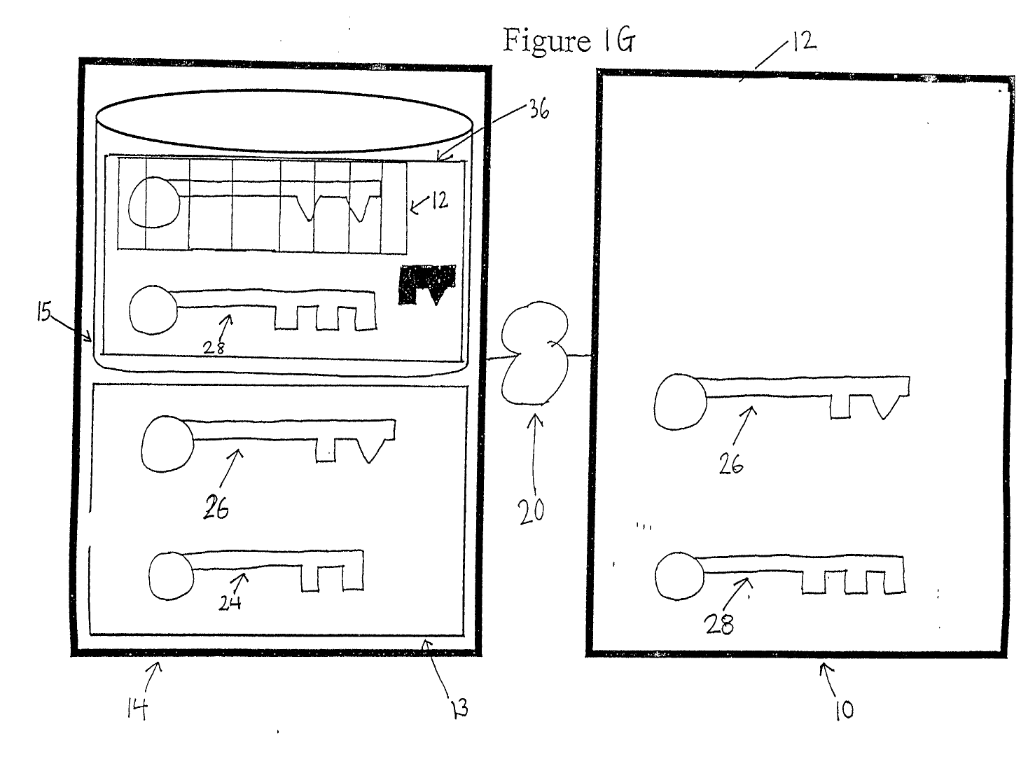

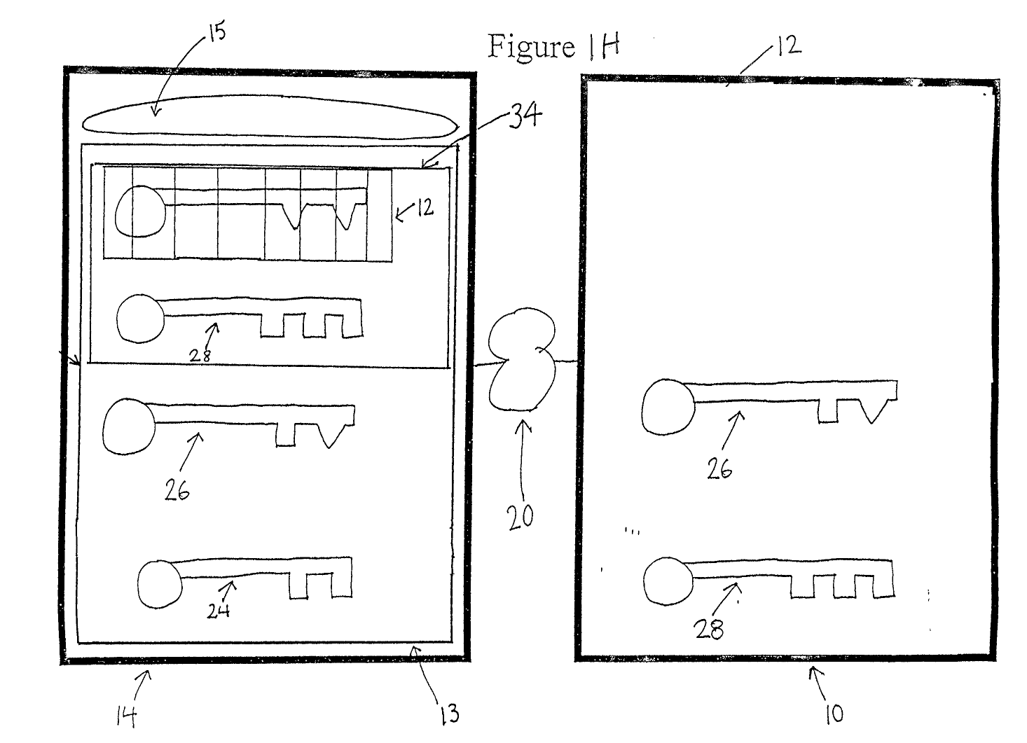

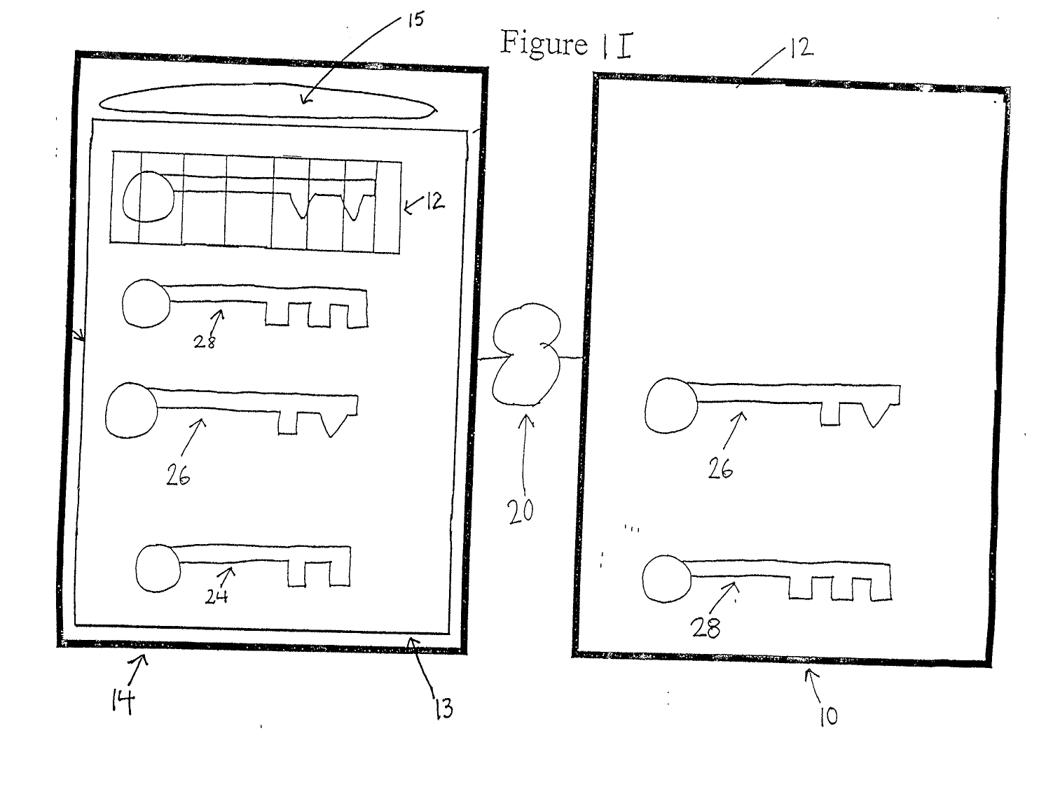

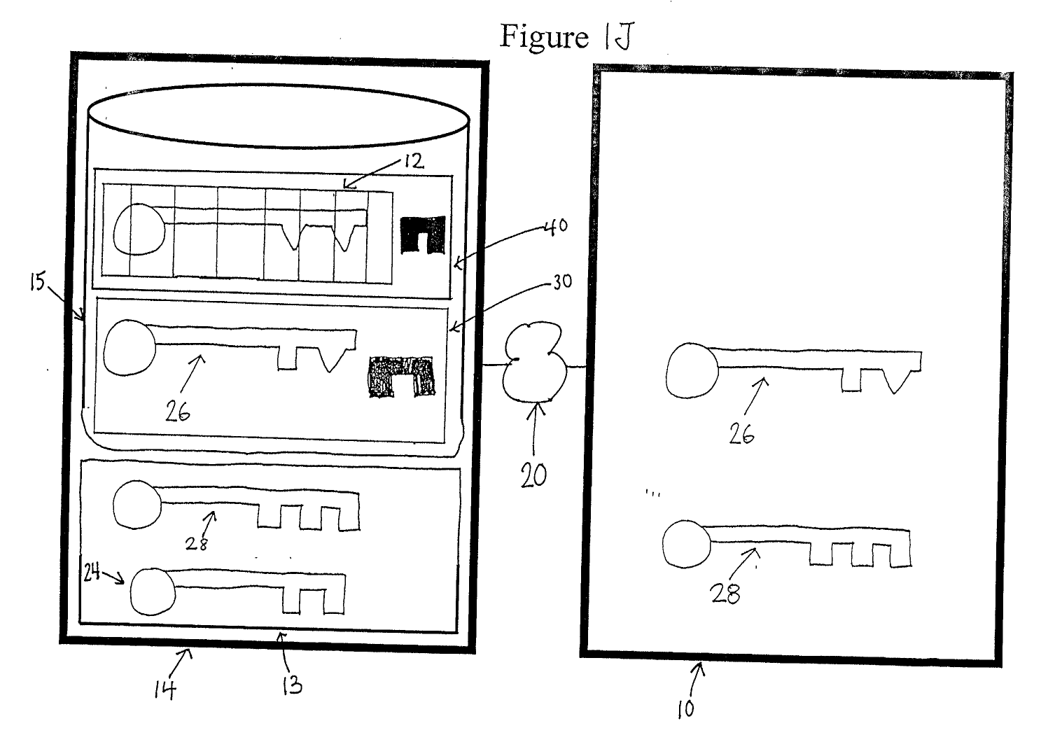

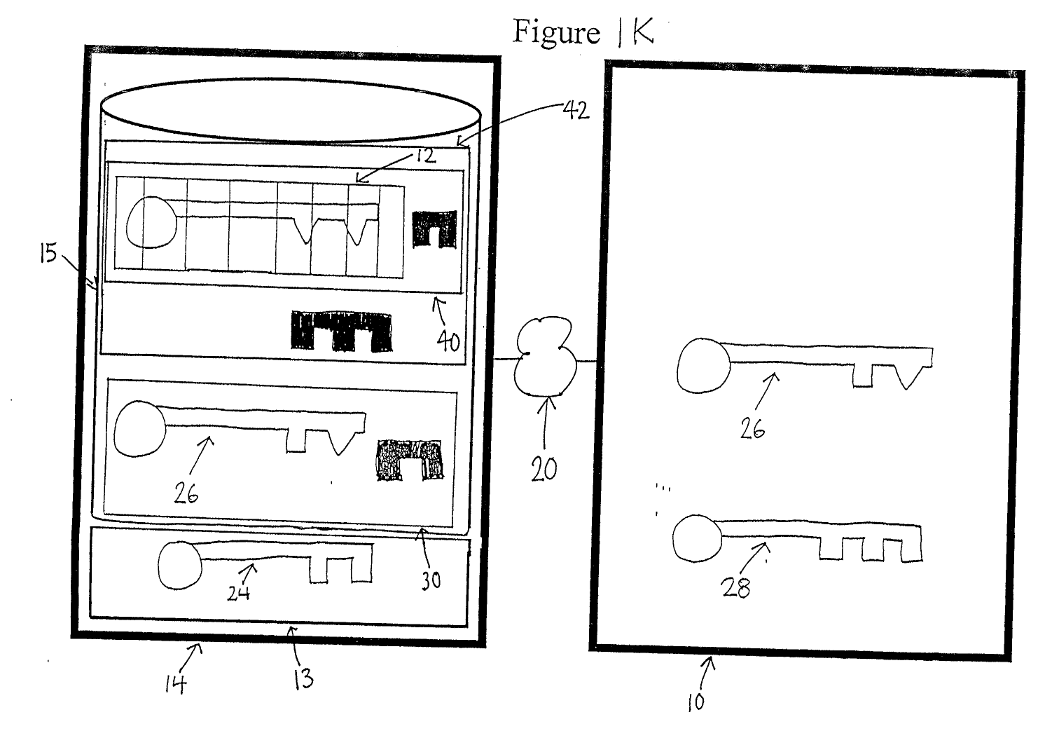

FIGS. 1A-1K illustrate a scheme that can protect keys stored in a database against a wide variety of malicious attacks. The scheme may include a variety of mechanisms that wrap a key in several layers of protection.

FIG. 1A shows a client 10, which may be a machine having a processor, for example, a computer, a personal digital assistant (PDA), a cellular phone, etc. As shown in FIG. 1A, the client 10 has access to an encrypted private key 12. The encrypted private key 12 includes a private key 16 protected by encryption 18 to inhibit access to the private key 16 by potentially malicious users. The client 10 or another entity may encrypt the private key 16. Encryption 18 may be performed by using a variety of encryption schemes, such as RSA Laboratories' Public Key Cryptography User Information Syntax Standard #12 (PCKS #12).

As also shown in FIG. 1A, a server 14 processes requests from and transmits responses to the client 10. The requests may include requests to store or retrieve the private key 16. The client 10 may communicate with the server 14 via a network connection 20. The client 10 and the server 14 may communicate over the World Wide Web by using a transfer protocol, such as hypertext transfer protocol (HTTP), file transfer protocol (FTP), user datagram protocol (UDP), and transfer control protocol/internet protocol (TCP/IP). Alternately, the client 10 and the server 14 may communicate over a variety of other media, for example, public networks, e.g. the landline telephone network, private networks, wireless systems, e.g. the cellular telephone system, and satellite-based systems. The network connection 20 may provide secure communication between the client 10 and the server 14. For example, the network connection 20 may be a dedicated pipeline or may use fiber optics which enhance security, a wireless system which inhibits sniffing, a Virtual Private Network (VPN), a Virtual Active Network (VAN), Secure Sockets Layer (SSL), Transport Level Security (TLS), and/or Internet Protocol Secure (IPSecure).

As further shown in FIG. 1A, the server 14 may access a server key 24. As explained in greater detail below, the server 14 utilizes the server key 24 to further encrypt the encrypted private key 12 and other items before storage in a database 15. The server 14 may generate the server key 24 based on data received during initialization of the server 14. The server 14 may generate the same server key 24 during different initializations, provided that the server 14 receives proper data during initialization. Preferably, as shown in FIG. 1A, the server 14 stores the server key 24 in temporary memory 13 (e.g., random access memory (RAM)). Also, preferably, only the server 14 may access the server key 24. By storing the server key 24 in temporary memory 13, the server 14 can prevent potentially malicious users from extracting the server key 24 from permanent storage, e.g. a hard disk.

Initialization of the server 14 refers to a variety of sequences during which the server 14 loads, reloads, or otherwise updates the entire server operating system or a component of the server operating system. Initialization includes sequences involving booting, rebooting, starting, and restarting the server.

The server key 24 may be generated based on data received via human interaction to inhibit access to the server key 24 by potentially malicious users. For example, the server key 24 may be generated based on a combination of usernames and passwords entered by one or more server administrators during initialization. The server 14 may fail to operate if any of the data required to be entered during initialization, for example, one or more usernames or passwords, are either not received or received incorrectly. Initialization of the server 14 may require receipt of data from more than one server administrator to inhibit a malicious server administrator from accessing the server key 24.

As further shown in FIG. 1A, the client 10 may access a first client key 26 and a second client key 28. As explained in greater detail below, the first client key 26 may be used to enable secure communication of the encrypted private key 12 and the second client key 28 between the client 10 and the server 14. The second client key 28 may be used by the server 14 to further encrypt the encrypted private key 12 before storage in the database 15.

In one implementation, the first and second client keys 26, 28 are generated by the client 10. The first and second client keys 26, 28 may be generated based on data received by the client 10. For example, the first and second client keys 26, 28 may be generated based on entry of a username and password by a user. Alternately, the first and second client keys 26, 28 may be generated based on data contained in a smart card.

Preferably, the client 10 generates first and second client keys 26, 28 that are different from each other. A variety of schemes may be used for generating keys satisfying this relationship. For example, the first client key 26 may be derived by hashing a combination of a dummy term and a password and/or a username. Using a dummy term makes forgery of the first client key 26 more difficult. The second client key 28 may then be generated by hashing a combination of the first client key 26 and the password and/or the username. The client 10 may always generate the same first client key 26 and the same second client key 28 provided that the client 10 receives proper data.

After generating the first and second client keys 26, 28, the client 10 may determine whether either the first client key 26 and/or the second client key 28 decrypts the encrypted private key 12. If either the first client key 26 and/or the second client key 28 decrypts the encrypted private key 12, the client 10 may generate new first and/or second client keys 26, 28. Using a first or second client key 26, 28 that decrypts the encrypted private key 12 increases the risk that a potentially malicious user will be able to access the private key 16 during the transmission scheme described below.

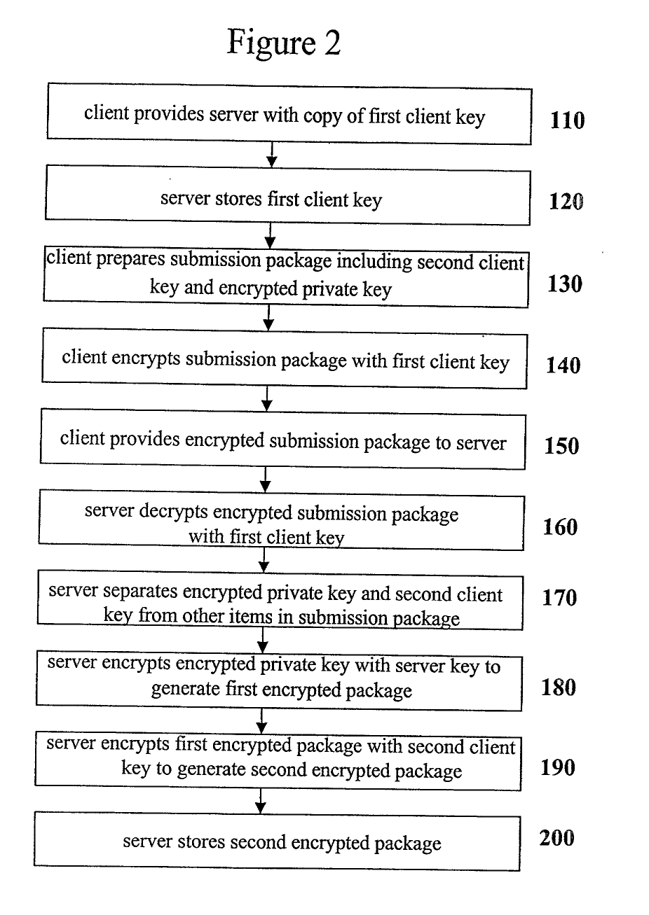

As shown in FIG. 1B, the client 10 may initiate storage of the encrypted private key 12 in the database 15 by providing the server 14 with a copy of the first client key 26 (110 in FIG. 2). The client 10 may transmit the copy of the first client key 26 via a secure network connection 20. The server 14 may store the first client key 26 upon receipt (120 in FIG. 2).

Alternately, as shown in FIG. 1C, the server 14 may encrypt the first client key 26 with the server key 24, and then store the encrypted first client key 30 in database 15. After storage, the server 14 may access the first client key 26 by retrieving the encrypted first client key 30 from database 15, accessing the server key 24, and decrypting the encrypted first client key 30 with the server key 24.

As suggested above, the first client key 26 is a “shared secret” between the server 14 and the client 10. During submission of the first client key 26, the client 10 may also submit data identifying the client to enable retrieval of the encrypted private key 12 by the client 10 from the server 14. The identifying data may include, for example, username(s), password(s), account number(s), and other data related to the client 10. The identifying data may then be associated with the first client key 26 and/or the encrypted first client key 30.

As shown in FIGS. 1D, 1E, and 1F, the client 10 may prepare the encrypted private key 12 and the second client key 28 for submission to the server 14 by using the first client key 26. As shown in FIG. 1D, the client 10 may combine the encrypted private key 12, a copy of the second client key 28, and other items, such as a token as described below, into a submission package 34 (130 in FIG. 2). As shown in FIG. 1E, the client 10 may subsequently encrypt the submission package 34 with the first client key 26 (140 in FIG. 2). As shown in FIG. 1F, the client 10 may then provide the encrypted submission package 36 to the server 14 over the network connection 20 (150 in FIG. 2). Like the first client key 26, the encrypted submission package 36 may also be associated with data identifying the client 10 to enable later retrieval of the encrypted private key 12 from the server 14.

A variety of schemes may be used to enhance the security of the encrypted private key submission scheme described above. For example, the encrypted private key 12 and the second client key 28 may be transmitted over a secure network connection 20. In this submission scheme, the encrypted private key 12 and the client key 28 do not need to be encrypted by the first client key 26 before submission.

Alternately, tokens may be used in the submission scheme. For example, the client 10 may submit a request to the server 14 to begin the submission scheme. In response, the server 14 may generate a random transaction token designed to inhibit replay of the submission transaction by potentially malicious users. The server 14 may then encrypt the token with the first client key 26 after accessing the first client key 26 from memory, and transmit the encrypted token to the client 10. To prepare the submission package 34, the client 10 may access the first client key 26 to decrypt the encrypted token, and then include the token in the submission package 34. After receiving the encrypted submission package 36 and decrypting the encrypted submission package 36, the server 14 may determine whether the token received from the client 10 matches the token generated by the server 14. Based on this determination, the server 14 may continue with the submission scheme and/or take other appropriate action.

As shown in FIGS. 1F-1I, the server 14 may prepare the encrypted private key 12 for storage by decrypting the encrypted submission package 36 (160 in FIG. 2). As shown in FIGS. 1F, 1G, and 1H, decrypting the encrypted submission package 36 may include accessing the first client key 26 from the encrypted first client key 30 (FIGS. 1F and 1G), and using the first client key 26 to decrypt the encrypted submission package 36 (FIGS. 1G and 1H). As shown in FIGS. 1H and 1I, after decrypting the encrypted submission package 36, the server 14 may extract the encrypted private key 12, the second client key 28, and any other items in the submission package 34 (170 in FIG. 2). The server 14 may associate the encrypted private key 12 with identifying data provided by the client 10 to enable later retrieval. Preferably, the server 14 stores the encrypted private key 12, the first client key 26, and the second client key 28 in temporary memory 13. Additionally, as shown in FIG. 1J, the server 14 may re-encrypt and store the first client key 26 after decrypting the encrypted submission package 36. Optionally, the server 14 may subsequently determine whether the first client key 26 and/or the second client key 28 decrypts the encrypted private key 24. Based on this determination, the server 14 may continue with the storage scheme and/or take other appropriate action, which may include notifying the client 10 that other first and/or second client keys 26, 28 may be desirable.

As shown in FIG. 1J, the server 14 may continue to prepare the encrypted private key 12 for storage by accessing the server key 24 and encrypting the encrypted private key 12 with the server key 24 to generate a twice encrypted private key 40 (180 in FIG. 2). The server 14 may subsequently store the twice encrypted private key 40 in database 15 for later access and retrieval, as described below. The server 14 may associate the twice encrypted private key 40 with identifying data provided by the client 10 to enable later retrieval.

Storing the encrypted private key 12 in the form of the twice encrypted private key 40 provides protection for the encrypted private key 12 against malicious users. For example, users who are not able to access the server key 24 will not have the ability to decrypt the twice encrypted private key 40. One or more server administrators may, however, conspire to generate the server key 24. Such administrators may be able to effectively attack the twice encrypted private key 40 since the twice encrypted private key 40 includes only one layer of protection for the encrypted private key 12 provided by the server key 24.

As shown in FIGS. 1J and 1K, the server 14 may further encrypt the encrypted private key 12 prior to storage. After generating the twice encrypted private key 40, the server 14 may access the second client key 28 from temporary memory 13 and encrypt the twice encrypted private key 40 with the second client key 28 to generate a thrice encrypted private key 42 (190 in FIG. 2). The server 14 may then store the thrice encrypted private key 42 in database 15 for later access and retrieval, as described below (200 in FIG. 2.) Optionally, the server 14 may encrypt the twice encrypted private key 40 with the second client key 28 on condition that the second client key 28 does not decrypt the encrypted private key 12. The server 14 may associate the thrice encrypted private key 42 with identifying data provided by the client 10 to enable later retrieval. Also, optionally, the server 14 may remove the second client key 28 from memory after encrypting the twice encrypted private key 40 with the second client key 28.

Storing the encrypted private key 12 on the server 14 in the form of the thrice encrypted private key 42 provides two independent layers of protection for the encrypted private key 12 against malicious users. The inner layer of protection is provided by the server key 24, and the outer layer of protection is provided by the second client key 28. The inner and outer layers of protection are independent because the server and second client keys 24, 28 are generated independently of each other, i.e., the server key 24 is generated by the server 14, and the second client key 28 is generated by the client 10.

As compared to the twice encrypted private key 40, the thrice encrypted private key 42 provides greater protection against server administrators who maliciously seek to access the encrypted private key 12. Even if the server administrators can generate the server key 24, they will not have the ability to decrypt the thrice encrypted private key 42 because the thrice encrypted private key 42 has an outer layer of protection provided by the second client key 28, and the second client key 28 is not stored on the server 14.

The server 14 may instantaneously decrypt the encrypted submission package 36, extract the components of the submission package 34, and encrypt the encrypted private key 12 with the server key 24 and, optionally, with the second client key 28 and, optionally, remove the second client key 28 from memory. Thus, the server 14 may perform decryption, separation, encryption, and optional removal on a time scale that inhibits interception and/or retrieval of the encrypted private key 12.

A variety of other schemes may also be utilized to inhibit the interception and/or retrieval of the encrypted private key 12. For example, these schemes may include memory protection schemes, in which memory that is provided to a first requesting application cannot be read by a second application (or another process) without permission from the first application.

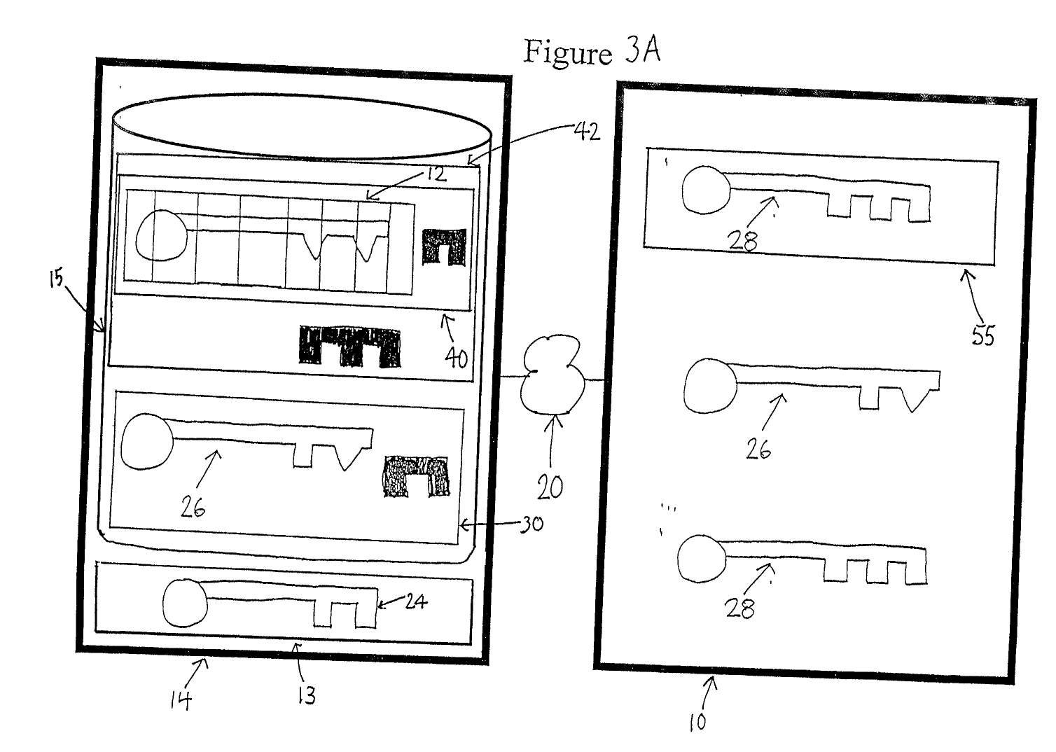

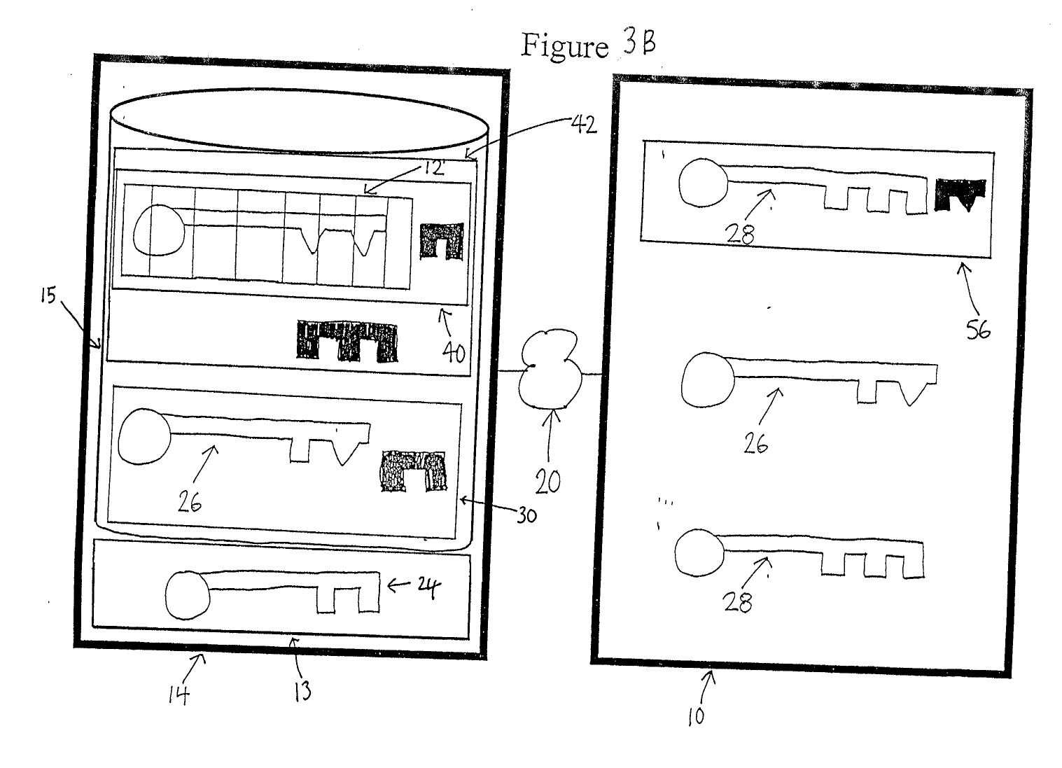

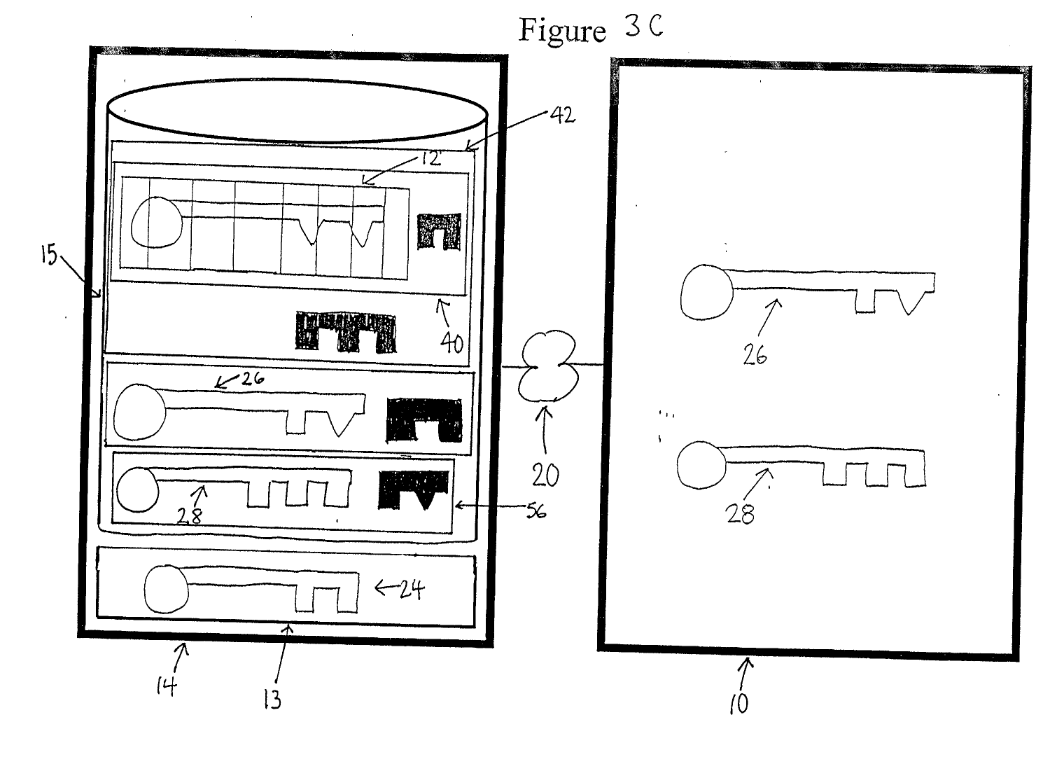

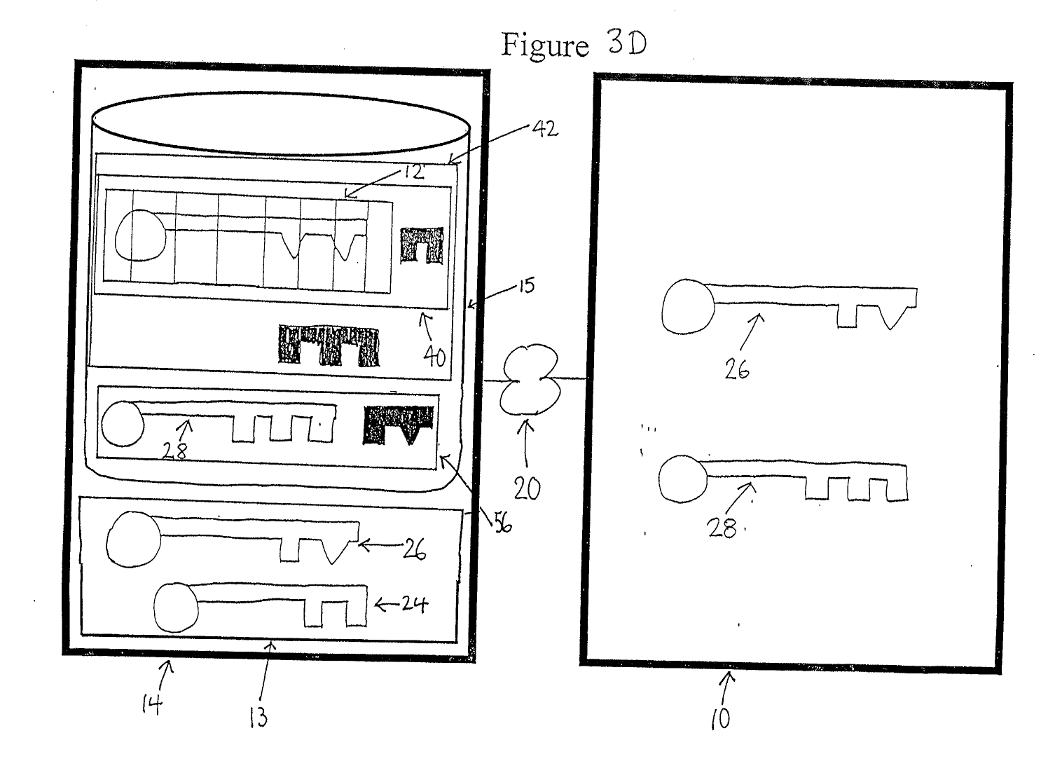

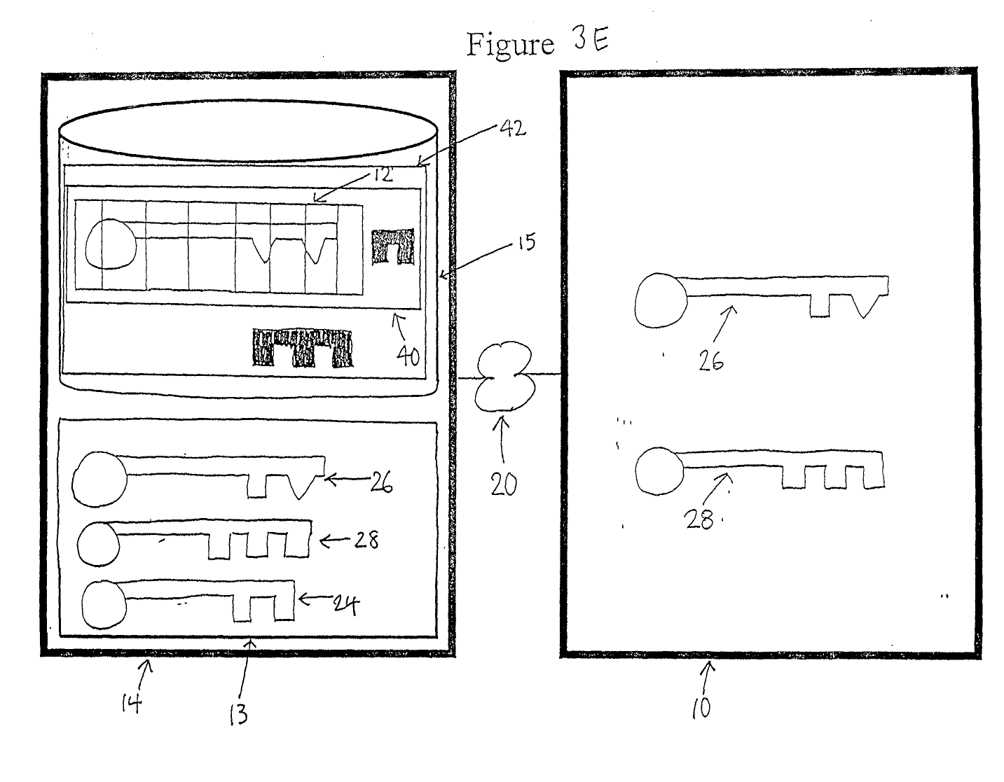

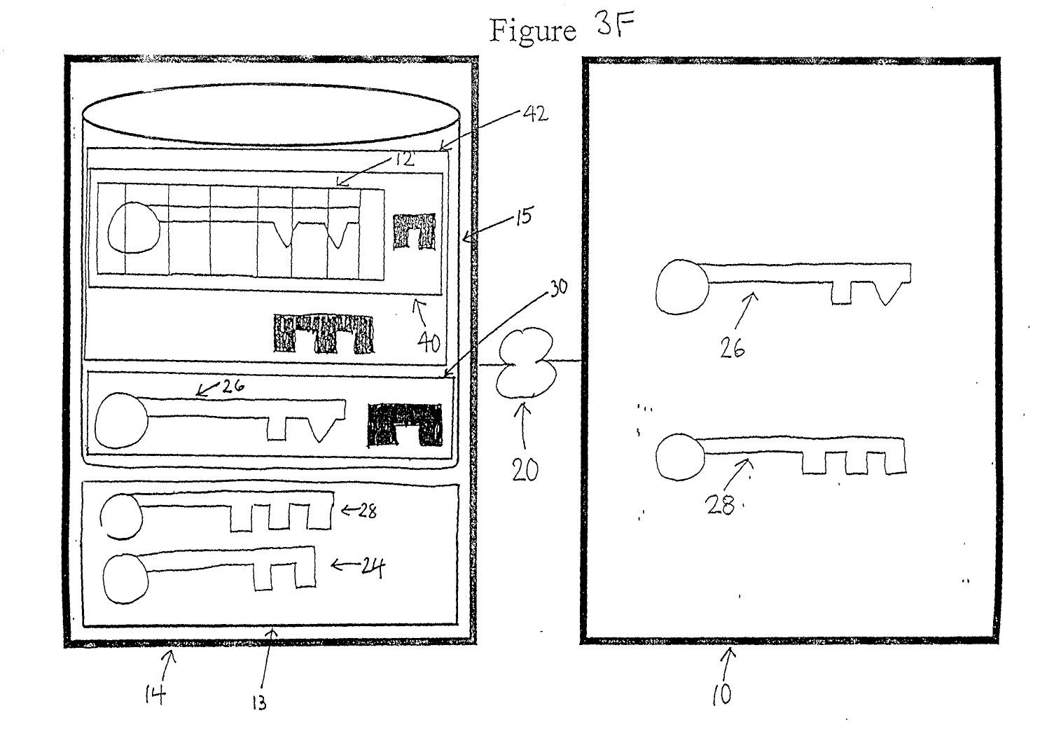

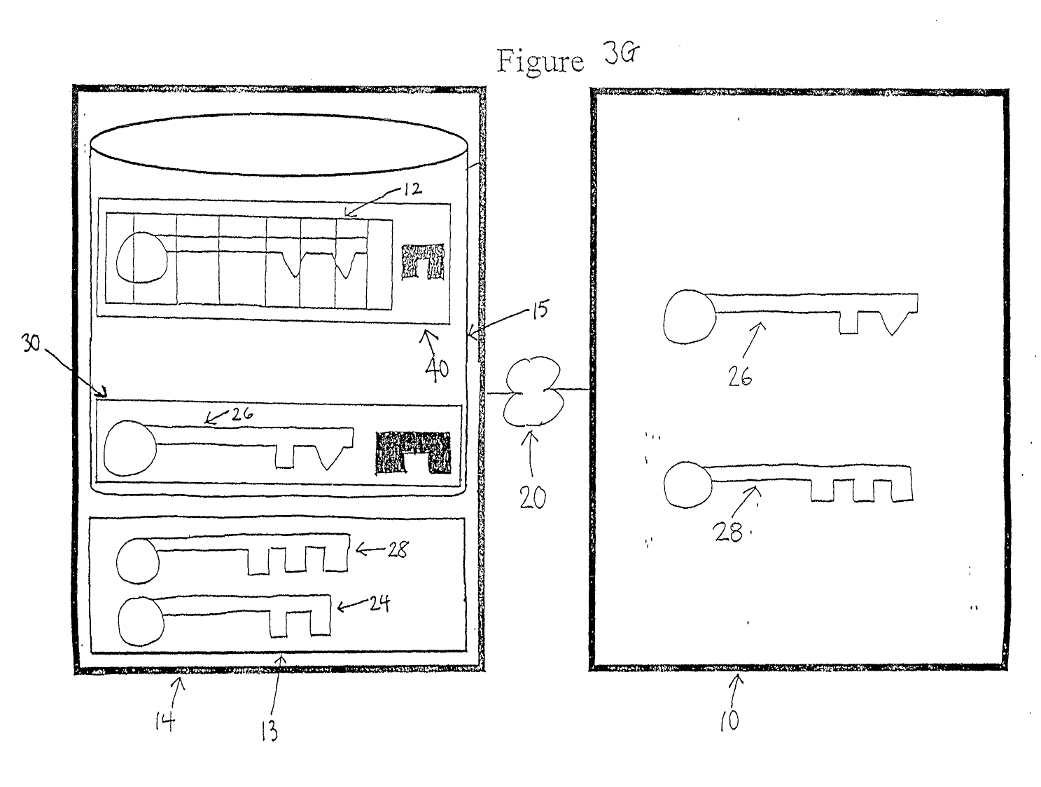

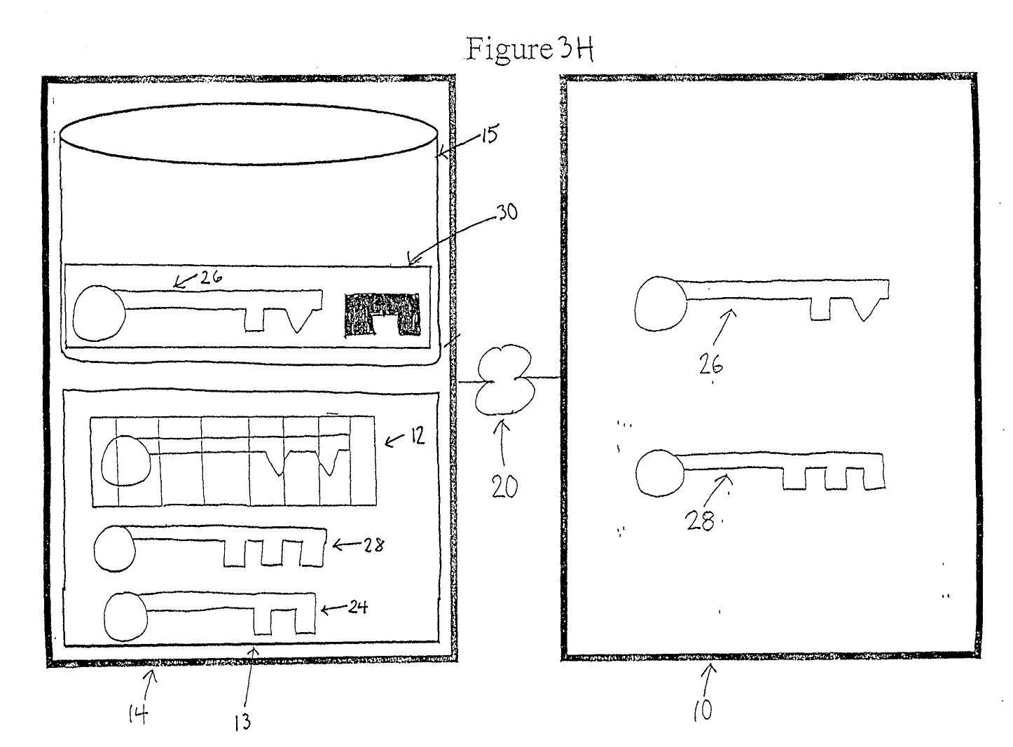

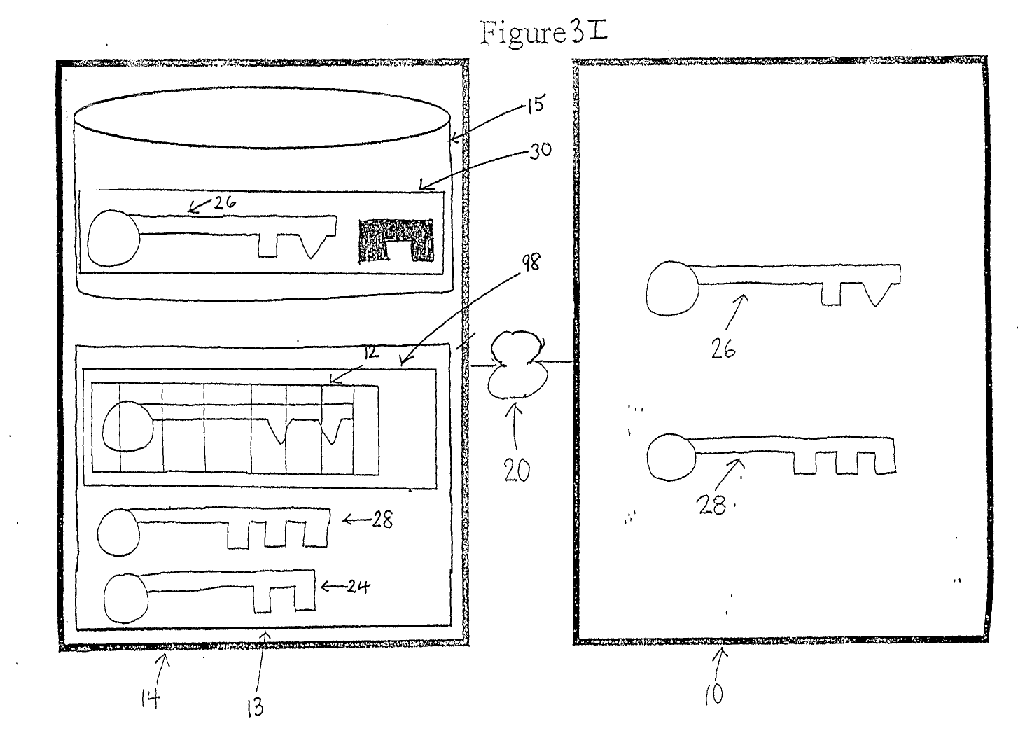

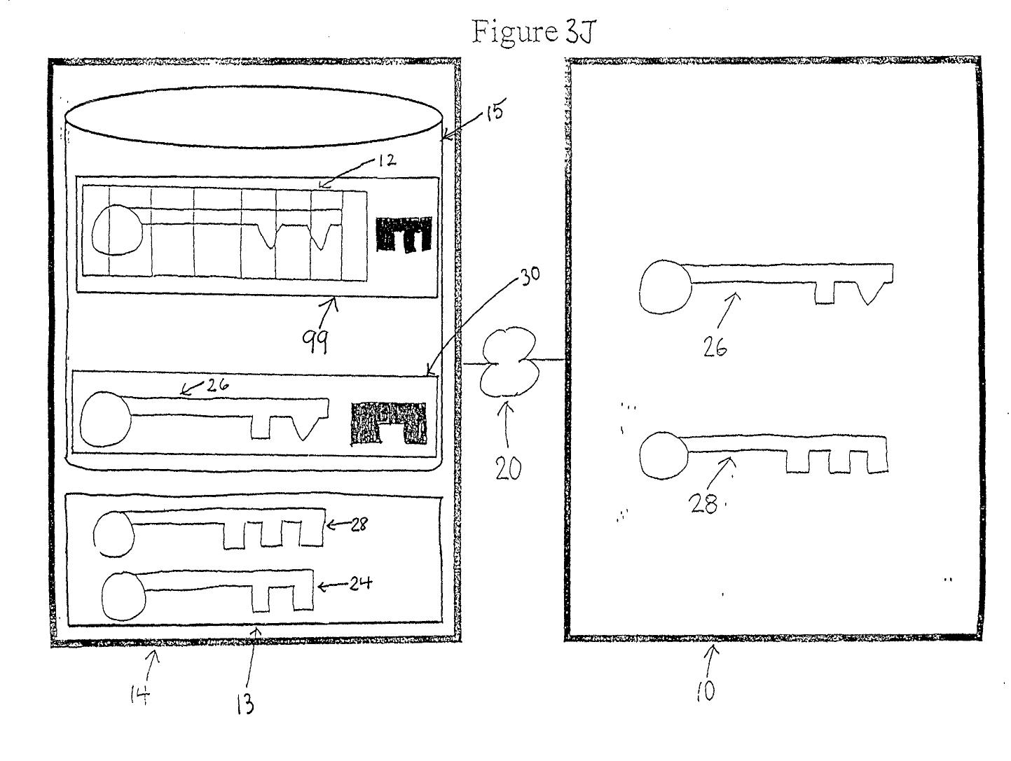

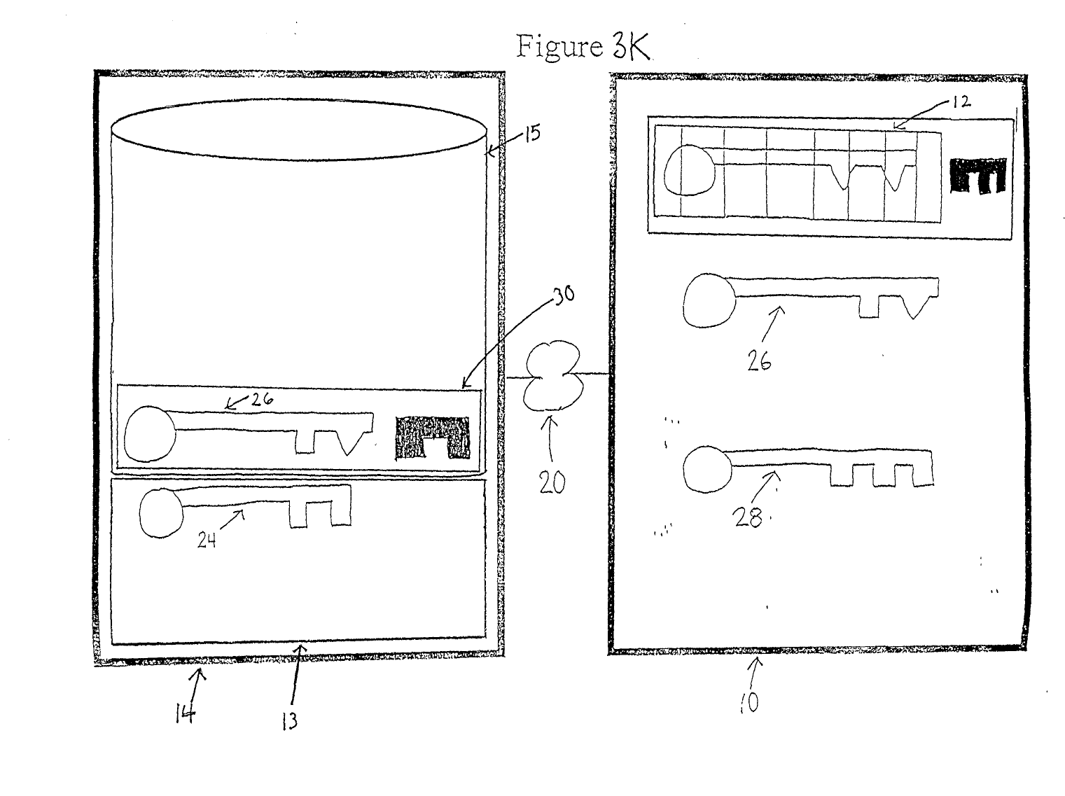

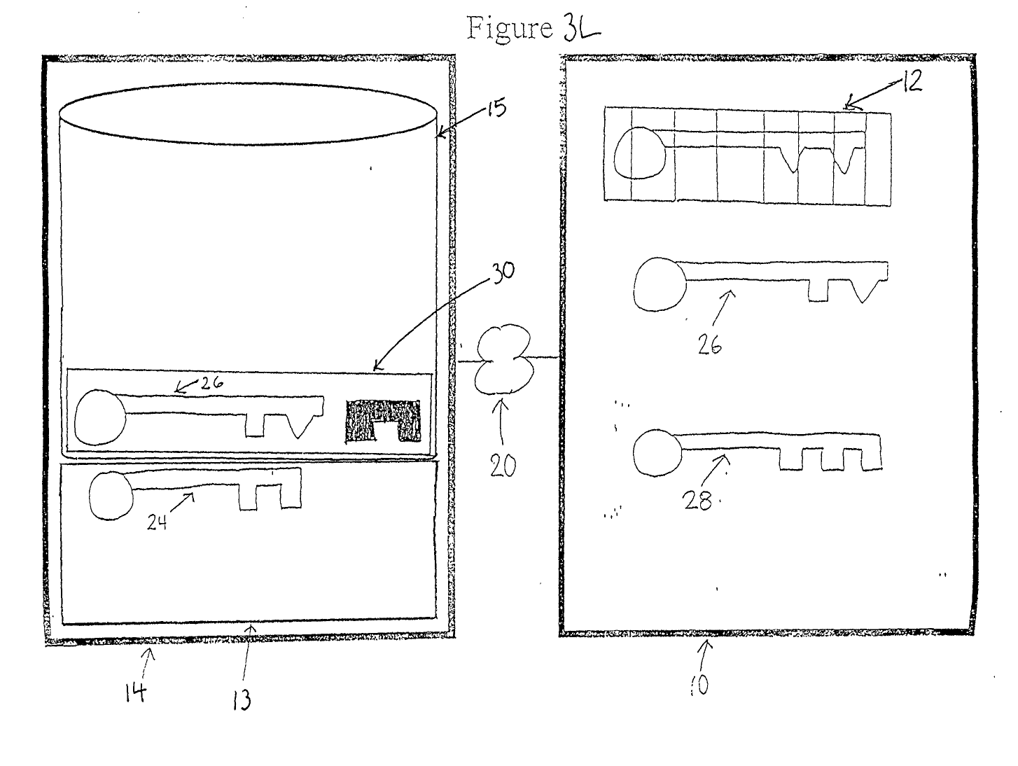

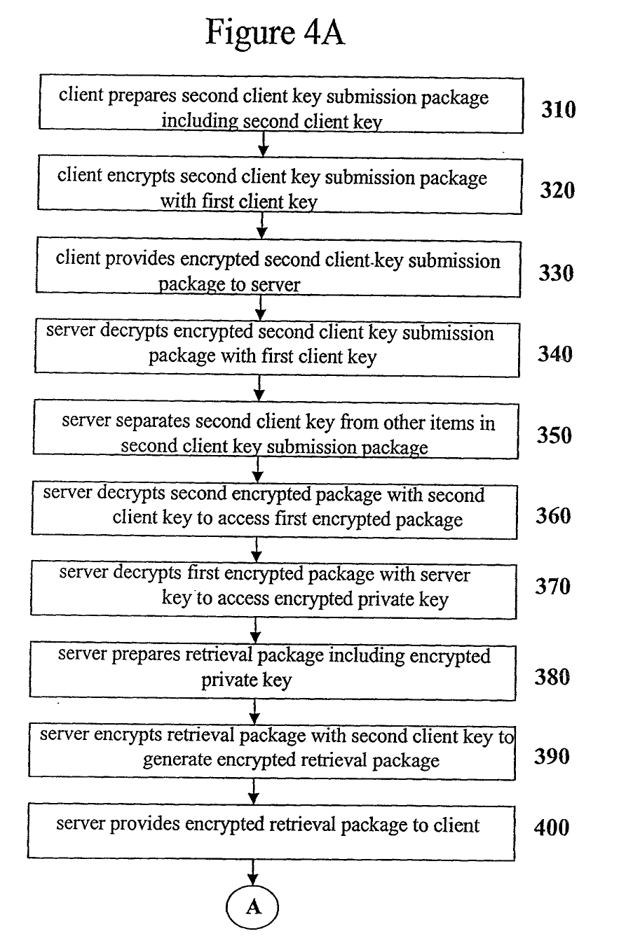

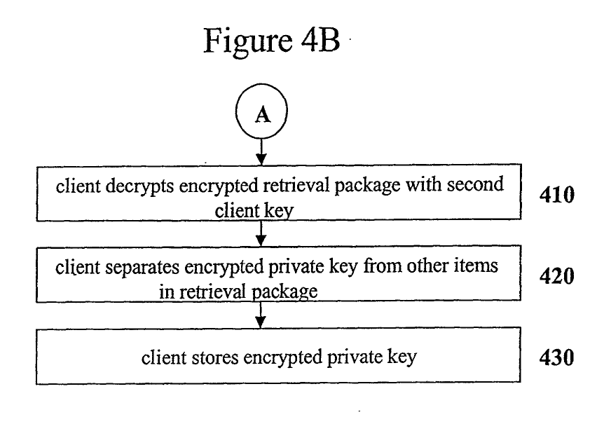

A scheme for retrieving an encrypted private key stored in a database is shown in the flow diagrams of FIGS. 1K and 3A-3L and in the corresponding flow charts of FIGS. 4A and 4B.

As shown in FIG. 1K, the client 10 has access to the first client key 26 and the second client key 28. As also shown in FIG. 1K, the server 14 has access to the server key 24, the encrypted first client key 30, and the thrice encrypted private key 42. As previously described, the encrypted first client key 30 and the thrice encrypted private key 42 may be associated with identifying data provided by the client 10.

In one implementation, the client 10 may initiate retrieval of the encrypted private key 12 by providing a retrieval request to the server 14. The retrieval request may be associated with identifying data provided by the client 10.

In the shown implementation, the server 14 may respond to the retrieval request with a second client key request.

As shown in FIGS. 3A, 3B, and 3C, the client 10 may respond to the second client key request by providing the server 14 with a copy of the second client key 28. As shown in FIG. 3A, the client 10 may prepare a copy of the second client key 28 for submission to the server 14 by combining the copy of the second client key 28 with other items including, e.g., a token, as previously described, into a second client key submission package 55 (310 in FIG. 4). As shown in FIG. 3B, the client 10 may subsequently encrypt the second client key submission package 55 with the first client key 26 (320 in FIG. 4). As shown in FIG. 3C, the client 10 may then provide the encrypted second client key package submission 56 to the server 14 (330 in FIG. 4).

A variety of schemes may be used to enhance the security of the second client key submission mechanism discussed above. For example, one or more of the schemes previously described for enhancing the encrypted private key submission mechanism may be suitably modified and used.

As shown in FIGS. 3C, 3D, and 3E, the server 14 may continue the retrieval scheme by decrypting the encrypted second client key package 56 (340 in FIG. 4). Decrypting the second encrypted client key package 56 may include accessing the first client key 26 from the encrypted first client key 30 (FIGS. 3C and 3D) and using the first client key 26 to decrypt the encrypted second client key package 56 (FIGS. 3D and 3E.) After decrypting the encrypted second client key package 56, the server 14 may extract the second client key 28 from the encrypted second client key package 56. Preferably, the server 14 subsequently stores the second client key 28 in temporary memory 13. Additionally, as shown in FIG. 3F, the server 14 may re-encrypt and store the first client key 26 as previously described after decrypting the encrypted second client key package 56.

Depending on the whether the server 14 stored the encrypted private key 12 in the form of the twice encrypted private key 40 or the thrice encrypted private key 42, the server 14 may continue the retrieval scheme by accessing the twice encrypted private key 40 or the thrice encrypted private key 42. As previously described, keys 40, 42 may be associated with identifying data from the client 10.

As shown in FIG. 3G, the server 14 may continue the retrieval scheme by accessing and decrypting the thrice encrypted private key 42 (360 in FIG. 4). Decrypting the thrice encrypted private key 42 may include accessing the second client key 28 and using the second client key 28 to decrypt the outer layer of encryption in the thrice encrypted private key 42. Decrypting the outer layer of encryption in the thrice encrypted private key 42 may permit access to the inner layer of encryption in the thrice encrypted private key 42, i.e., access to the twice encrypted private key 40.

As shown in FIG. 3H, the server 14 may continue the retrieval scheme by decrypting the inner layer of encryption in the thrice encrypted private key 42 (370 in FIG. 4). Decrypting the inner layer of encryption may include accessing the server key 24 and using the server key 24 to decrypt the inner layer of encryption in the thrice encrypted private key 42. Decrypting the inner layer of encryption may permit access to the encrypted private key 12.

A variety of schemes may be used by the server 14 to provide the encrypted private key 12 to the client 10, for example, one or more of the schemes previously described herein.

An exemplary scheme for providing the encrypted private key 12 to the client 10 is shown in FIGS. 3I, 3J, and 3K. As shown in FIG. 3I, the server 14 may combine the encrypted private key 12 with other items, such as a token, as previously described, into a retrieval package 98 (380 in FIG. 4). As shown in FIG. 3J, the server 14 may subsequently encrypt the retrieval package 98 with the second client key 28 (390 in FIG. 4). As shown in FIG. 3K, the server 14 may then provide the encrypted retrieval package 99 to the client 10 (400 in FIG. 4).

The server 14 may instantaneously encrypt the encrypted private key 12 with the second client key 28 after removing the inner layer of encryption in the thrice encrypted private key 42. Thus, the server 14 may perform decryption and encryption on a time scale that inhibits interception and/or retrieval of the encrypted private key 12. The server 14 may also instantaneously remove the second client key 28 from temporary memory 13 after encrypting the encrypted private key 12 with the second client key 28.

As shown in FIG. 3L, the client 10 may access the encrypted private key 12 by accessing the second client key 28, using the second client key 28 to decrypt the encrypted retrieval package 99, and extracting the encrypted private key 12 from the encrypted retrieval package 99 (410 and 420 in FIG. 4). The client 10 may then store the encrypted private key 12 for later use (430 in FIG. 4).

After encrypting the encrypted private key 12 with the second client key 28, the server 14 retains the first client key 26 in permanent memory in the form of the encrypted first client key 30. As such, the client 10 may initiate subsequent storage of the encrypted private key 12 on the server 14 by following a scheme similar to that previously described. During subsequent storage, the client 10 may not need to provide the first client key 26 to the server 14.

Alternately, after encrypting the encrypted private key 12 with the second client key 28, the server 14 may instantaneously remove the first client key 26 from memory. The client 10 may then initiate subsequent storage of the encrypted private key 12 by following a scheme similar to that previously described.

Preferably, the server 14 does not retain a copy of the encrypted private key 12 after providing the encrypted private key 12 to the client 10. Alternately, the server 14 may retain a copy of the encrypted private key 12 to enable subsequent retrieval by the client 10.

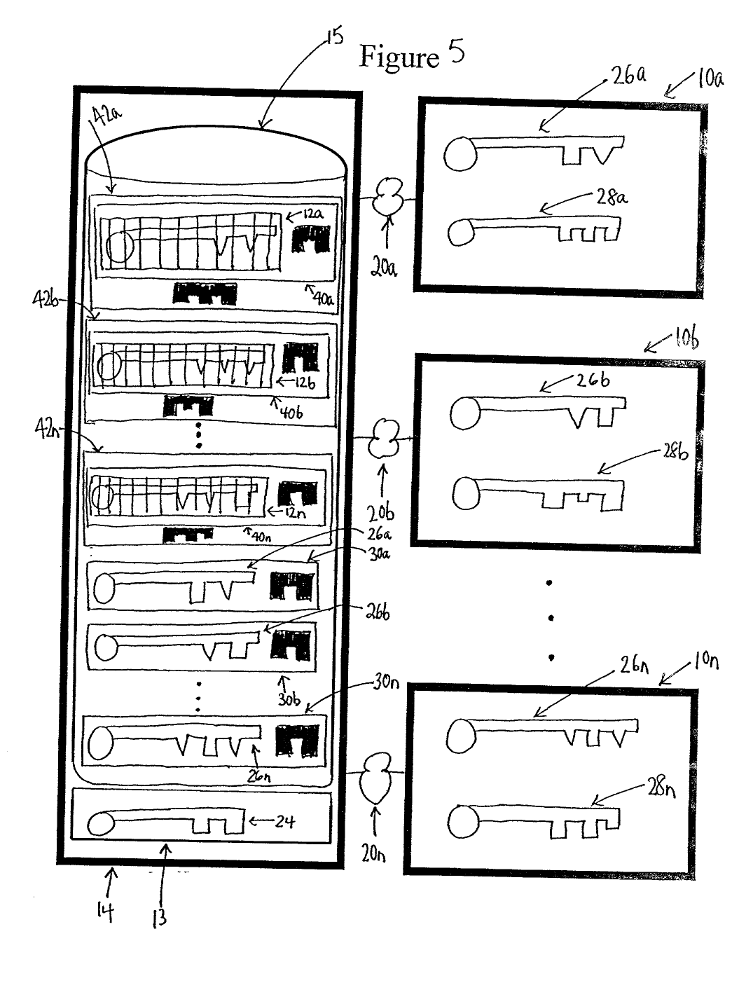

FIG. 5 illustrates a server 14 storing in a database 15 multiple private keys 12a, 12b, 12n provided by corresponding multiple clients 10a, 10b, 10n. Clients 10a, 10b, 10n may access corresponding first client keys 26a, 26b, 26n and second client keys 28a, 28b, 28n. By following schemes described previously, clients 10a, 10b, 10n may provide corresponding encrypted private keys 12a, 12b, 12n to the server 14 over network connections 20a, 20b, 20n, and the server 14 may encrypt the encrypted private keys 12a, 12b, 12n to generate corresponding twice encrypted private keys 40a, 40b, 40n and thrice encrypted private keys 42a, 42b, 42n.

During submission of first client keys 26a, 26b, 26n, clients 10a, 10b, 10n may also submit identifying data to enable later retrieval of the encrypted private keys 12a, 12b, 12n. The server 14 may then associate the identifying data with corresponding first client keys 26a, 26b, 26n, encrypted first client keys 30a, 30b, 30n, encrypted private keys 12a, 12b, 12n, twice encrypted private keys 40a, 40b, 40n, and/or thrice encrypted private keys 42a, 42b, 42n.

Clients 10a, 10b, 10n may retrieve corresponding encrypted private keys 12a, 12b, 12n by following schemes described previously. For example, client 10b may initiate retrieval by providing a retrieval request to the server 14. The server 14 may respond to the retrieval request with a second client key request. The client 10b may respond to the second client key request by providing the server 14 with a copy of the second client key 28b. The server 14 may then continue the retrieval scheme by accessing the first client key 26b and the thrice encrypted private key 42b associated with identifying data provided by client 10b. By following schemes previously described, the server 14 may subsequently provide the encrypted private key 12b to the client 10b. Associating the thrice encrypted private keys 42a, 42b, 42n and other items with data identifying corresponding clients 10a, 10b, 10n enables the server 14 and the database 15 to store multiple encrypted private keys 12a, 12b, 12n provided by multiple clients 10a, 10b, 10n.

The schemes previously described may be suitably modified to permit a single client to store multiple encrypted private keys in a database.

The schemes previously described may not be limited to a particular hardware or software configuration; they may find applicability in many computing or processing environments. The schemes may be implemented in hardware or software, or a combination thereof. Preferably, the schemes are implemented in processor programs.

The processor programs may be implemented in high level procedural or object oriented programming language to communicate with a computer system. However, the processor programs can be implemented in assembly or machine language, if desired. In any case, the language may be compiled or interpreted language.

The processor programs can be stored on a storage media or device(s) (e.g., CD-ROM, hard disk, or magnetic disk) that are readable by a general or special purpose programmable processor for configuring and operating the processor when the storage medium or device is read by the processor to perform the schemes described herein. The system may also be considered to be implemented as a processor-readable storage medium, configured with a processor program, where the storage medium so configured causes a processor to operate in a specific and predefined manner.

While the methods, processor programs, and products for managing cryptographic keys disclosed herein have been particularly shown and described with reference to the exemplary embodiments thereof, those of ordinary skill in the art will understand that various changes may be made in the form and details herein without departing from the spirit and scope of the disclosure. Those of ordinary skill in the art will recognize or be able to ascertain many equivalents to the exemplary embodiments described specifically herein by using no more than routine experimentation. Such equivalents are intended to be encompassed by the scope of the present disclosure and the appended claims.

I claim:

1. A method of managing cryptographic keys, the method comprising:
accessing at a server a server key;
accessing at the server a client key;
accessing at the server an encrypted private key provided by a client;
encrypting the encrypted private key with the server key to generate a twice encrypted private key; and
encrypting the twice encrypted private key with the client key to generate a thrice encrypted private key.

2. The method of claim 1, further comprising:
generating at the server a server key.

3. The method of claim 2, wherein generating at the server the server key comprises generating at the server the server key based on data received during server initialization.

4. The method of claim 3, wherein generating at the server the server key further comprises generating at the server the same server key during different server initializations.

5. The method of claim 2, further comprising:
storing at the server the server key in temporary memory only.

6. The method of claim 5, wherein accessing at the server the server key comprises retrieving the server key from temporary memory.

7. The method of claim 1, further comprising:
receiving at the server client data identifying the client; and
associating at the server the client key and the thrice encrypted private key with the client data.

8. The method of claim 1, further comprising:
receiving at the server the client key from the client.

9. The method of claim 8, wherein receiving at the server the client key from the client comprises receiving at the server the client key from the client via a network connection.

10. The method of claim 9, wherein the network connection connects the client to at least one of a public network, a private network, a wireless system, a satellite-based system, the World Wide Web, and the landline telephone network.

11. The method of claim 1, further comprising:
receiving at the server the encrypted private key from the client.

12. The method of claim 11, wherein receiving at the server the encrypted private key from the client comprises receiving at the server the encrypted private key from the client via a network connection.

13. The method of claim 12, wherein the network connection connects the client to at least one of the telephone network and the World Wide Web.

14. The method of claim 1, further comprising:
determining whether the client key decrypts the encrypted private key.

15. The method of claim 14, wherein encrypting the twice encrypted private key with the client key to generate the thrice encrypted private key comprises encrypting the twice encrypted private key with the client key to generate the thrice encrypted private key if the client key does not decrypt the encrypted private key.

16. The method of claim 1, further comprising:
storing at the server the thrice encrypted private key.

17. The method of claim 16, further comprising:
receiving a request from the client for the encrypted private key corresponding to the thrice encrypted private key stored at the server.

18. The method of claim 17, further comprising:
providing the encrypted private key to the client.

19. The method of claim 18, further comprising:
accessing at the server the thrice encrypted private key;
accessing at the server the server key;
accessing at the server the client key;
decrypting the thrice encrypted private key with the client key to access the twice encrypted private key; and
decrypting the twice encrypted private key with the server key to access the encrypted private key.

20. The method of claim 1, further comprising:
performing the method of claim 1 for multiple clients; and
for at least some of the multiple clients, storing at the server the corresponding thrice encrypted private key.

21. The method of claim 20, further comprising:
for at least some of the multiple clients, receiving at the server client data identifying the corresponding client; and
for at least some of the multiple clients, associating at the server the corresponding client key and the corresponding thrice encrypted private key with the corresponding client data.

22. The method of claim 21, further comprising:
receiving requests from the multiple clients for the encrypted private keys corresponding to the thrice encrypted private keys stored at the server.

23. The method of claim 22, further comprising:
providing the corresponding encrypted private key to at least some of the multiple clients.

24. The method of claim 23, further comprising for at least some of the multiple clients:
accessing at the server the thrice encrypted private key associated with the corresponding client data;
accessing at the server the server key;
accessing at the server the client key associated with the corresponding client data;
decrypting the thrice encrypted private key with the client key to access the twice encrypted private key; and
decrypting the twice encrypted private key with the server key to access the corresponding encrypted private key.

25. A method of managing cryptographic keys, the method comprising:
accessing at a server a server key;
accessing at the server an encrypted private key provided by a client; and
encrypting the encrypted private key with the server key to generate a twice encrypted private key.

26. The method of claim 25, further comprising:
generating at the server the server key.

27. The method of claim 26, further comprising:
storing at the server the server key in temporary memory only.

28. The method of claim 27, wherein accessing at the server the server key comprises retrieving the server key from temporary memory.

29. The method of claim 25, further comprising:
storing at the server the twice encrypted private key.

30. The method of claim 29, further comprising:
receiving a request from the client for the encrypted private key corresponding to the twice encrypted private key stored at the server.

31. The method of claim 30, further comprising:
providing the encrypted private key to the client.

32. The method of claim 31, further comprising:
accessing at the server the twice encrypted private key;
accessing at the server the server key; and
decrypting the twice encrypted private key with the server key to access the encrypted private key.

33. A method of managing cryptographic keys, the method comprising:
accessing at a server a server key;
accessing at the server a first client key;
accessing at the server a first package encrypted with the first client key, the first package including at least an encrypted private key provided by a client and a second client key;
decrypting the first package with the first client key;
extracting at least the second client key and the encrypted private key from the first package;
encrypting the encrypted private key with the server key to generate a twice encrypted private key; and
encrypting the twice encrypted private key with the second client key to generate a thrice encrypted private key.

34. The method of claim 33, further comprising:
receiving the first client key from the client.

35. The method of claim 34, wherein receiving the first client key from the client comprises receiving the first client key from the client using only a secure network connection.

36. The method of claim 35, wherein the secure network connection includes at least one of a dedicated pipeline, fiber optics which enhance security, a wireless system which inhibits sniffing, a Virtual Private Network (VPN), a Virtual Active Network (VAN), Secure Sockets Layer (SSL), Transport Level Security (TLS), and Internet Protocol Secure (IPSecure).

37. The method of claim 33, further comprising:
comparing the first client key with the second client key.

38. The method of claim 33, further comprising:
determining whether the second client key decrypts the encrypted private key.

39. The method of claim 38, wherein encrypting the twice encrypted private key with the second client key comprises encrypting the twice encrypted private key with the second client key if the second client key does not decrypt the encrypted private key.

40. A processor program for managing cryptographic keys, the processor program being tangibly stored on a processor-readable medium and comprising instructions operable to cause a processor to:
access at a server a server key;
access at the server an encrypted private key provided by a client; and
encrypt the encrypted private key with the server key to generate a twice encrypted private key.

41. The processor program of claim 40, further comprising instructions operable to cause a processor to:
access at the server a client key; and
encrypt the twice encrypted private key with the client key to generate a thrice encrypted private key.

42. A product for managing cryptographic keys, the product comprising:
multiple twice encrypted private keys, at least some of the multiple twice encrypted private keys including an encrypted private key provided by a client, the encrypted private key being further encrypted by a server key generated at a server.

43. The product of claim 42, wherein the at least some of the multiple twice encrypted private keys are further encrypted by a client key provided by the client.

44. A product for managing cryptographic keys, the product comprising:
multiple thrice encrypted private keys, at least some of the multiple thrice encrypted private keys including an encrypted private key being further encrypted by two independent layers of encryption.
